(19) United States
(12) Patent Application Publication
(10) Pub. No.: US 2011/0206353 A1
(43) Pub. Date: Aug. 25, 2011

(54) TELEVISON APPARATUS

(75) Inventor: Ansley YEO, Ome-shi (JP)

(73) Assignee: KABUSHIKI KAISHA TOSHIBA, Tokyo (JP)

(21) Appl. No.: 12/960,158

(22) Filed: Dec. 3, 2010

(30) Foreign Application Priority Data
Feb. 24, 2010 (JP) 2010-038241

(51) Int. Cl. H04N 5/76; H04N 5/63

(52) U.S. Cl. 386/291; 348/730; 386/E05.003; 348/E05.127

(57) ABSTRACT

In one embodiment, there is provided a television apparatus. The television apparatus includes: a display configured to display video; an audio output module configured to output audio; a confirmation module configured to confirm the presence of a viewer; and a power controller configured to supply an electric power to at least the display and the audio output module. The power controller is configured to continue the electric power supplied to the audio output module while limiting the electric power supplied to the display at a first time point, and then is configured to limit the electric power supplied to the audio output module at a second time point after the first time point, if the confirmation module cannot confirm the presence of the viewer before the first time point.

### CROSS-REFERENCE TO RELATED APPLICATION

This application claims priority from Japanese Patent Application No. 2010-038241, filed on Feb. 24, 2010, the entire contents of which are hereby incorporated by reference.

### BACKGROUND

1. Field

Embodiments described herein generally relate to a television apparatus which outputs video and audio.

2. Description of the Related Art

A technique which can suppress power consumption of an electronic apparatus such as a television apparatus is required with a recent rise in awareness of environmental issues.

As an example of the technique for suppressing power consumption of a television apparatus, there is a technique which can turn on/off a display based on whether an viewer is watching a program actually or not (e.g. JP-A-2006-180179). JP-A-2006-180179 discloses a television set which has a camera for capturing an image of an viewer and which determines a direction of eyes, nose, mouth, etc. of the viewer from the image captured by the camera so that a video signal is supplied to a display device when the viewer's eyes or the like are directed to the display device, but the video signal is not supplied to the display device to turn off electric power of the display device while audio is outputted when the viewer's eyes or the like are not directed to the display device.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A to 1C are views showing the form of use of a television apparatus according to an embodiment of the invention;

FIG. 2 is a block diagram showing the system configuration of the television apparatus according to the embodiment of the invention;

FIG. 3 is a flow chart showing an example of processing operation in the television apparatus according to the embodiment of the invention;

FIG. 4 is a flow chart showing an example of processing operation in the television apparatus according to the embodiment of the invention; and

FIG. 5 is a flow chart showing an example of processing operation in the television apparatus according to the embodiment of the invention.

### DETAILED DESCRIPTION

According to exemplary embodiments of the present invention, there is provided a television apparatus. The television apparatus includes: a display configured to display video; an audio output module configured to output audio; a confirmation module configured to confirm the presence of a viewer; and a power controller configured to supply an electric power to at least the display and the audio output module. The power controller is configured to continue the electric power supplied to the audio output module while limiting the electric power supplied to the display at a first time point, and then is configured to limit the electric power supplied to the audio output module at a second time point after the first time point, if the confirmation module cannot confirm the presence of the viewer before the first time point.

An embodiment of the invention will be described below with reference to the drawings.

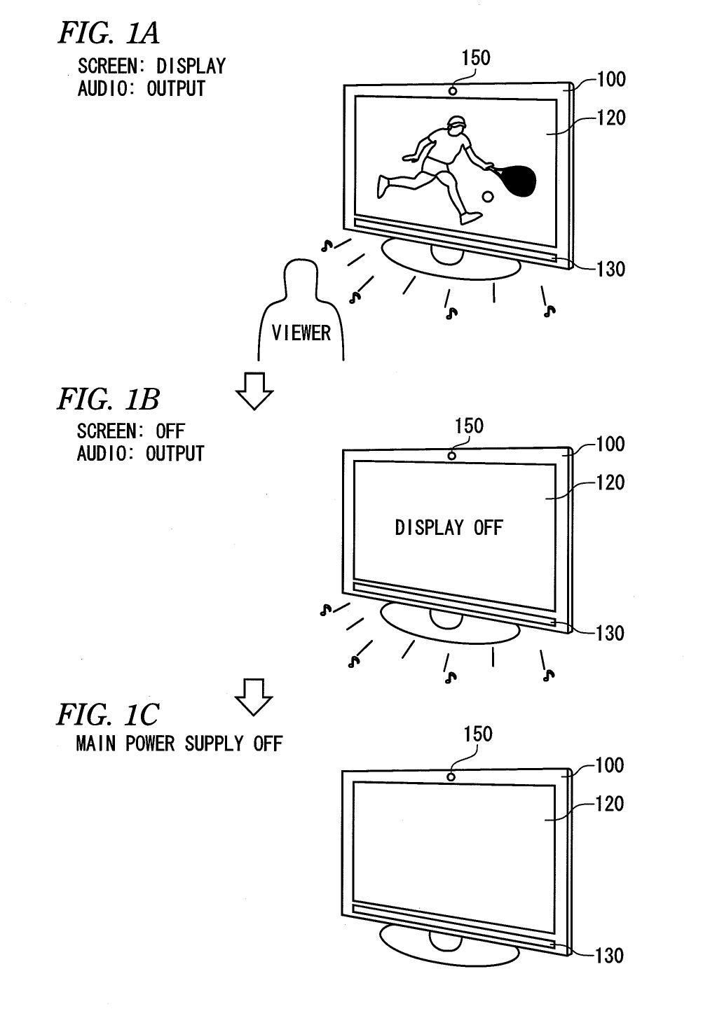

FIGS. 1A to 1C are views showing the form of use of a television apparatus 100 according to the embodiment. The television apparatus 100 includes a receiver 101 (not shown in FIGS. 1A to 1C), a display 120, a speaker 130, an image capturing module 150, etc. The receiver 101 receives television broadcast waves on which data of broadcast contents of television programs, broadcast start/end times, etc. are superposed. The display 120 and the speaker 130 output video and audio of broadcast contents received by the receiver 101. Incidentally, the television apparatus 100 further has a function of recording data of broadcast contents received by the receiver 101 and playing back the recorded broadcast contents. The image capturing module 150 is a camera or the like which captures an image of an area surrounding the television apparatus 100.

The television apparatus 100 confirms the presence of a viewer around the television apparatus 100 based on the image captured by the image capturing module 150. When the television apparatus 100 confirms the presence of a viewer, the television apparatus 100 detects the direction of the viewer's eyes or the like to thereby determine whether the viewer is watching the television apparatus 100 or not. Then, the television apparatus 100 limits electric power supplied to the display 120, the speaker 130 and the whole television apparatus 100 in accordance with whether it is possible to confirm the presence of any viewer around the television apparatus 100 or not, whether the viewer is watching the television apparatus 100 or not, and so on.

That is, when the viewer is watching video displayed on the television apparatus 100, the television apparatus 100 outputs video at the display 120 and audio at the speaker 130 as shown in FIG. 1A. When it is impossible to confirm the presence of any viewer as shown in FIG. 1B, the television apparatus 100 limits electric power supplied to the display 120 but continues electric power supplied to the speaker 130 and audio outputted at the speaker.

Then, the television apparatus 100 can limit audio outputted at the speaker 130 and limit a main power supply of the television apparatus 100 as shown in FIG. 1C at a viewer's preferable timing after power supply to the display 120 is limited.

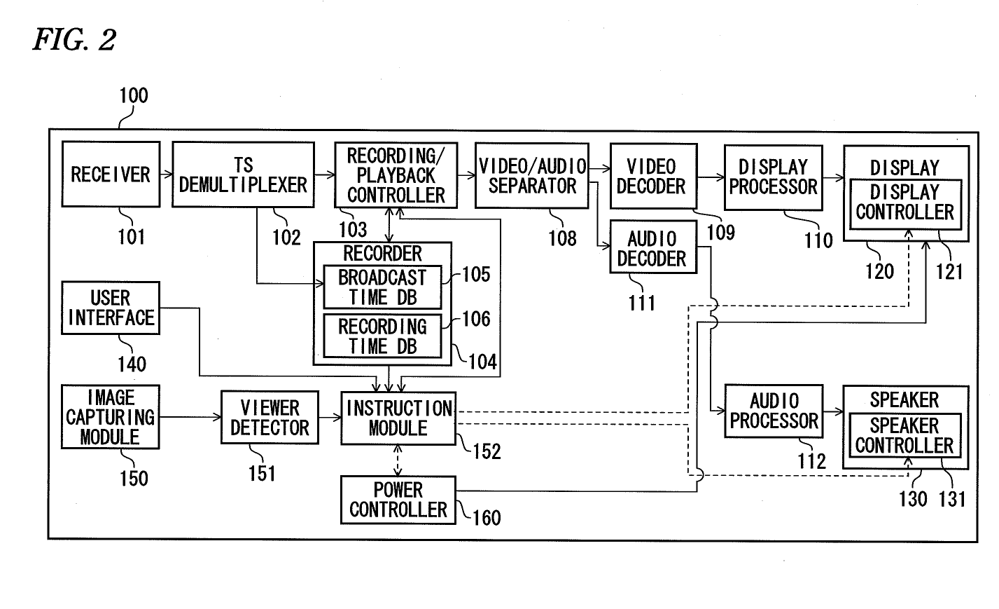

The system configuration of the television apparatus 100 will be described next with reference to FIG. 2.

The television apparatus 100 includes a receiver 101, a TS demultiplexer 102, a recording/playback controller 103, a recorder 104, a video/audio separator 108, a video decoder 109, a display processor 110, an audio decoder 111, an audio processor 112, a display 120, a speaker 130, a user interface 140, an image capturing module 150, a viewer detector 151, an instruction module 152, a power controller 160, etc.

The receiver 101 receives television broadcast waves on which data of broadcast contents and broadcast time information about the broadcast contents are superposed, through an antenna (not shown). Then, the receiver 101 outputs the received data of broadcast contents and broadcast time information to the TS demultiplexer 102.

The TS demultiplexer 102 demultiplexes the TS inputted from the receiver 101, into an EIT (Event Information Table) or the like on which audio data, video data and information such as broadcast program start/end time, program title, etc. are written. Then, the TS demultiplexer 102 outputs the demultiplexed audio data and video data to the recording/playback controller 103 and the EIT to the recorder 104.

The recording/playback controller 103 controls a playback process and a recording process. Incidentally, the playback process includes a process of playing back broadcast contents currently received by the receiver 101 and broadcast contents already recorded on the recorder 104, a process of playing back video contents already recorded on a portable recording medium such as a DVD, etc.

In the process of playing back broadcast contents currently received by the receiver 101, the recording/playback controller 103 outputs video data and audio data inputted from the TS demultiplexer 102, to the video/audio separator 108. In the process of playing back broadcast contents already recorded on the recorder 104, the recording/playback controller 103 reads video data and audio data of broadcast contents already recorded on the recorder 104, and then outputs the data to the video/audio separator 108. Incidentally, the recording/playback controller 103 also reads information concerned with the playback time length of the read broadcast contents.

On the other hand, in the process of recording broadcast contents received by the receiver 101, the recording/playback controller 103 outputs video data and audio data inputted from the TS demultiplexer 102, to the recorder 104. The recording/playback controller 103 further has a reserved recording function which creates a recording time database 106 for managing start/end times or the like with respect to set reserved recording, and then outputs the recording time database 106 to the recorder 104.

The recorder 104 records video data and audio data inputted from the recording/playback controller 103. The recorder 104 further records a broadcast time database 105 based on the EIT inputted from the TS demultiplexer 102 and the recording time database 106 inputted from the recording/playback controller 103. The broadcast time database 105 is a database concerned with the start time, the end time, etc. of each broadcast program. The recording time database 106 is a database concerned with the start time, the end time, etc. of each reserved recording.

The video/audio separator 108 separates video data and audio data inputted from the recording/playback controller 103, and then outputs the separated video data to the video decoder 109 and the separated audio data to the audio decoder 111.

The video decoder 109 decodes video data inputted from the video/audio separator 108, and then outputs the decoded video data to the display processor 110. Successively, the display processor 110 generates a video signal based on the video data inputted from the video decoder 109, and then outputs the video signal to the display 120.

The display 120 displays video based on the video signal inputted from the display processor 110.

The audio decoder 111 decodes audio data inputted from the video/audio separator 108, and then outputs the decoded audio data to the audio processor 112.

Successively, the audio processor 112 generates an audio signal based on the audio data inputted from the audio decoder 111, and then outputs the audio signal to the speaker 130.

The speaker 130 outputs audio based on the audio signal inputted from the audio processor 112.

The user interface 140 accepts an operation input signal from a remote controller (not shown) or the like. For example, the user interface 140 accepts an operation input signal etc. for limiting electric power supplied to the display 120, and then outputs a notification based on the accepted signal to the instruction module 152.

The image capturing module 150 is a camera or the like for capturing an image of an area surrounding the television apparatus 100. The image capturing module 150 outputs the captured image data to the viewer detector 151. Incidentally, the image capturing module 150 need not have an image capturing function such as a camera. For example, the image capturing module 150 may be a motion sensor or the like for detecting a moving object around the television apparatus 100. In this case, the image capturing module 150 notifies the viewer detector 151 of whether there is any moving object around the television apparatus 100 or not. Although it is unnecessary that the image capturing module 150 can capture an image in all directions around the television apparatus 100, it is preferable that the image capturing module 150 can capture an image in front of the television apparatus 100, that is, on the display 120 side in order to capture an image of the viewer watching the television apparatus 100.

The viewer detector 151 analyzes video data inputted from the image capturing module 150 and detects an image of a human figure from the video to thereby confirm the presence of a viewer around the television apparatus 100. When an image of a human figure is detected in the analyzed video, the viewer detector 151 further detects the face, line-of-sight direction, etc. of the human figure to thereby determine whether the human figure is watching the television apparatus 100 or not. Incidentally, when a plurality of human figures are confirmed in the video, the viewer detector 151 detects the line-of-sight direction, etc. of each of the human figures to thereby determine whether at least one of the human figures is watching the television apparatus 100 or not. Then, the viewer detector 151 outputs a notification as to whether the presence of a viewer around the television apparatus 100 can be confirmed or not, and whether at least one of users is watching the television apparatus 100 or not, to the instruction module 152.

When a notification as to whether a moving object is detected or not, is received from the image capturing module 150 in the case where the image capturing module 150 is a motion sensor or the like, the viewer detector 151 outputs a notification as to whether the presence of a viewer around the television apparatus 100 can be confirmed or not, based on the notification to the instruction module 152.

The instruction module 152 issues an instruction to control driving power of the display 120, the speaker 130, etc. based on the notification as to whether the presence of a viewer can be confirmed or not, and whether the viewer is watching the television apparatus 100 or not.

That is, upon reception of the notification indicating the absence of any viewer from the viewer detector 151, the instruction module 152 instructs the power controller 160 to limit driving power of the display 120. On this occasion, the instruction module 152 may instruct the video decoder 109 to stop decoding of video data (a signal of the instruction is not shown).

Upon reception of the notification indicating the absence of any viewer, the instruction module 152 may instruct the display controller 121 to ratchet down luminance of the display 120 for a predetermined time and instruct the power controller 160 to limit driving power supplied to the display 120 after the predetermined time has passed.

When limitation of electric power supplied to the display 120 is started, the instruction module 152 starts a counter. When the value of the counter reaches a set value, that is, after a predetermined time has passed since the start of limitation of electric power supplied to the display 120, the instruction module 152 instructs the power controller 160 to limit electric power supplied to the speaker 130 and respective components of the television apparatus 100. The set value to be compared with the value of the counter may be set by the viewer. Incidentally, “to limit electric power supplied to respective components of the television apparatus 100” means to shift the mode of the television apparatus 100 to a so-called standby mode.

Incidentally, the instruction module 152 may instruct the speaker controller 131 to ratchet down the volume of audio outputted from the speaker 130 for a predetermined time after a predetermined time has passed since the limitation of electric power supplied to the display 120, and instruct the power controller 160 to limit driving power supplied to the speaker 130 after the predetermined time has passed.

After the instruction module 152 instructs the power controller 160 to limit electric power supplied to the display 120, the instruction module 152 may further instruct the power controller 160 to limit electric power supplied to the speaker 130 after completion of broadcasting of broadcast contents played back by the recording/playback controller 103 or after completion of a recording process. On this occasion, the instruction module 152 reads the broadcast time database 105 recorded on the recorder 104 and extracts the broadcast end time of the currently played back broadcast contents from the database. Then, when it comes to the broadcast end time, the instruction module 152 instructs the power controller 160 to limit electric power supplied to the speaker 130 and respective components of the television apparatus 100.

When the recording/playback controller 103 is operating to play back recorded broadcast contents, the instruction module 152 acquires the playback end time of the recorded broadcast contents from the recording/playback controller 103. Then, when it comes to the playback end time, the instruction module 152 instructs the power controller 160 to limit electric power supplied to the speaker 130.

The instruction module 152 further reads the recording time database 106 recorded on the recorder 104 and extracts the end time of reserved recording from the database. Then, when it comes to the end time of reserved recording, the instruction module 152 instructs the power controller 160 to limit electric power supplied to the television apparatus 100. The instruction module 152 may inquire of the recording/playback controller 103 whether recording is currently performed or not.

When a notification for instructing limitation of electric power supplied to the display 120 is inputted from the user interface 140, the instruction module 152 may instruct the power controller 160 to limit electric power supplied to the display 120.

The power controller 160 supplies driving power to respective components of the television apparatus 100. The power controller 160 limits driving power supplied to the display 120 and the speaker 130 respectively and limits driving power supplied to respective components of the television apparatus 100 based on the instruction given from the instruction module 152.

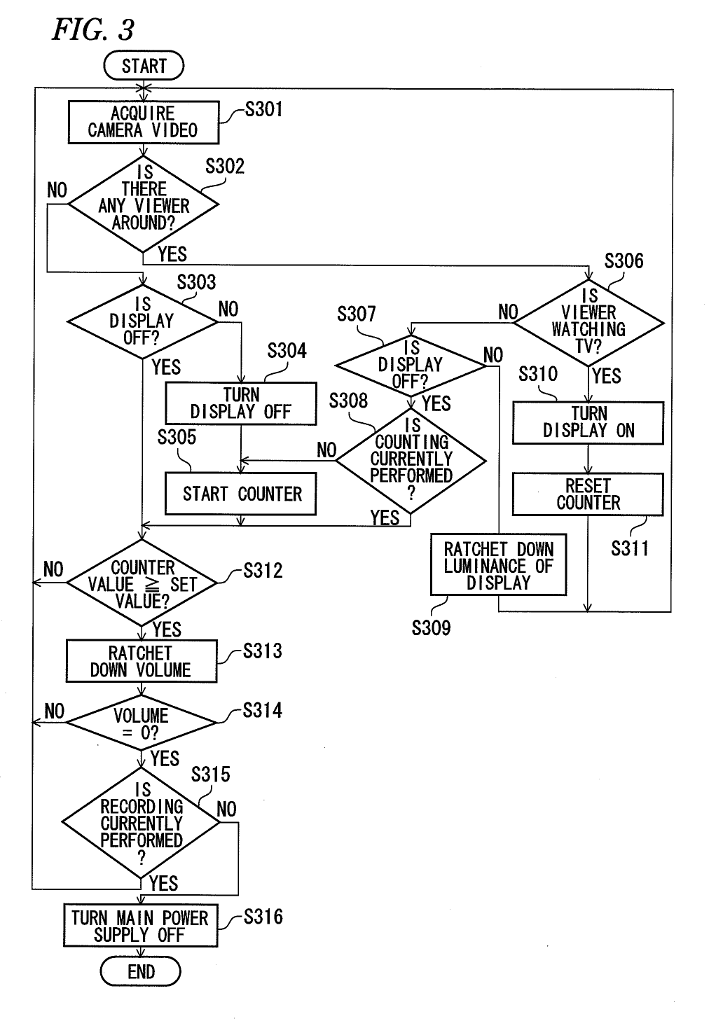

An example of processing sequence in the television apparatus 100 according to this embodiment will be described next with reference to FIG. 3.

First, the viewer detector 151 acquires video captured by the image capturing module 150 (S301). Then, the viewer detector 151 analyzes the video and determines whether the presence of any viewer in the video can be confirmed or not (S302). When the presence of any viewer cannot be confirmed (No in S302), the instruction module 152 inquires of the power controller 160 about driving power of the display 120 and determines whether electric power is supplied to the display 120 or not (S303). When electric power is supplied to the display 120 (No in S303), the instruction module 152 instructs the power controller 160 to limit electric power supplied to the display 120 (S304).

Incidentally, in S304, the instruction module 152 may instruct the display controller 121 to ratchet down luminance of the display 120 for a predetermined time and instruct the power controller 160 to limit electric power supplied to the display 120 after the predetermined time has passed. Then, the instruction module 152 starts the counter (S305) and determines whether the value of the counter reaches a set value or not (S312). When the value of the counter does not reach the set value (No in S312), the television apparatus 100 performs processing in S301.

On the other hand, when the presence of any viewer in the video captured by the image capturing module 150 can be confirmed in S302 (Yes in S302), the viewer detector 151 detects the line-of-sight direction, etc. of the viewer and determines whether the viewer is watching the television apparatus 100 or not (S306). When the viewer is not watching the television apparatus 100 (No in S306), the instruction module 152 determines whether driving power is supplied to the display 120 or not (S307).

When electric power is not supplied to the display 120 (Yes in S307), the instruction module 152 determines whether counting is currently performed or not (S308). When counting is currently performed (Yes in S308), processing in S312 is performed. When counting is not currently performed (No in S308), processing in S305 is performed.

On the other hand, when it is concluded in S307 that electric power is supplied to the display 120 (No in S307), the instruction module 152 instructs the display controller 121 to ratchet down luminance of the display 120 for a predetermined time and instructs the power controller 160 to limit electric power supplied to the display 120 after the predetermined time has passed (S309). Incidentally, in S309, the instruction module 152 may alternatively issue an instruction so that electric power supplied to the display 120 is limited while luminance of the display 120 is not ratcheted down.

When it is concluded in S306 that the viewer is watching the television apparatus 100 (Yes in S306), the instruction module 152 instructs the power controller 160 to supply electric power to the display 120. When the display controller 121 performs control to ratchet down luminance of the display 120, the instruction module 152 in S310 instructs the display controller 121 to restore luminance of the display 120 to the previous value before lowering of luminance and stop the control of ratcheting down luminance. Successively, the instruction module 152 resets the counter (S311), so that the television apparatus 100 performs processing in S301.

When the television apparatus 100 performs processing in S301 to S312 so that the value of the counter is not lower than the set value (Yes in S312), the instruction module 152 instructs the speaker controller 131 to ratchet down the volume of audio outputted from the speaker 130 and instructs the power controller 160 to limit electric power supplied to the speaker 130 when the volume of audio becomes zero (S313). Incidentally, in S313, the instruction module 152 may instruct the power controller 160 to limit electric power supplied to the speaker 130 when the volume of audio is not larger than a predetermined value.

When the volume of audio outputted from the speaker 130 becomes zero (Yes in S314), the instruction module 152 successively inquires of the recording/playback controller 103 whether recording is currently performed or not, and determines whether recording is currently performed or not (S315). When recording is currently performed (Yes in S315), the television apparatus 100 performs processing in S301 again. Incidentally, when it is concluded in S315 that recording is currently performed, the instruction module 152 may read the recording time database 106 recorded on the recorder 104 and extract the recording end time from the database. Accordingly, when processing in S301 to S315 is repeated, the television apparatus 100 can determine whether the recording process is completed or not, without inquiring of the recording/playback controller 103 one by one in S315.

On the other hand, when it is concluded in S315 that recording is not currently performed (No in S315), the instruction module 152 instructs the power controller 160 to limit electric power supplied to respective components of the television apparatus 100.

Although the processing flow shown in FIG. 3 has been described in the case where the image capturing module 150 can capture an image, the image capturing module 150 may be a sensor or the like for detecting the presence of any viewer as described above. In this case, processing in S306 to S311 in the processing flow shown in FIG. 3 may be removed.

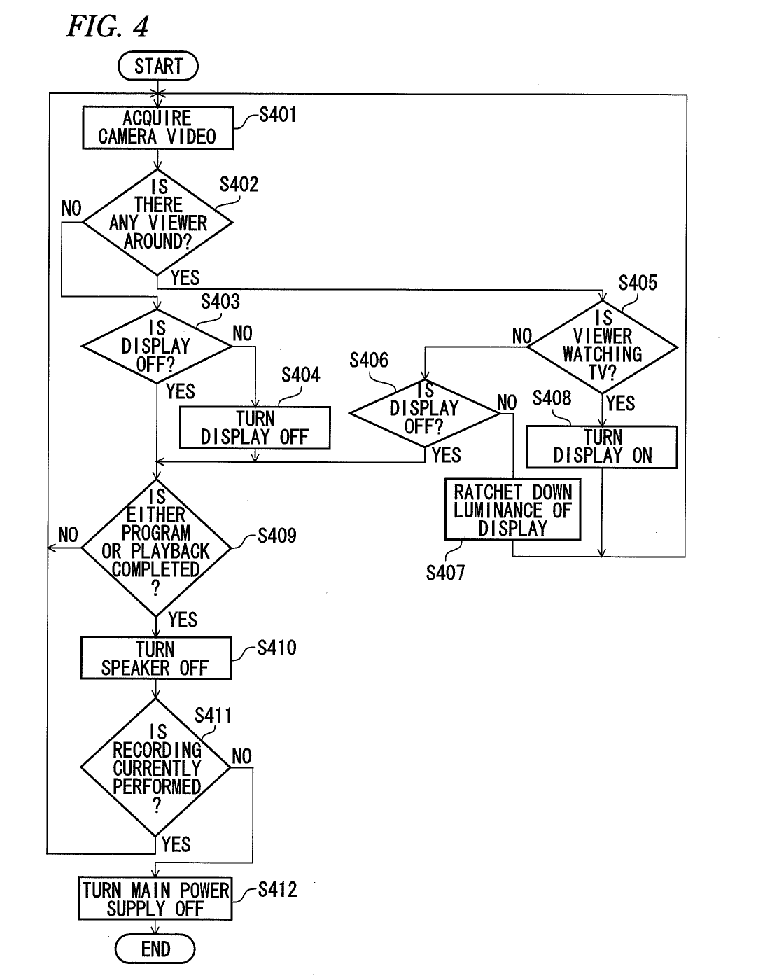

An example of processing sequence in the television apparatus 100 according to this embodiment will be described next with reference to FIG. 4. In the processing flow shown in FIG. 3, the television apparatus 100 is configured so that electric power supplied to the speaker 130 is limited when a predetermined time has passed since electric power supplied to the display 120 is limited. On the other hand, in the processing flow shown in FIG. 4, the television apparatus 100 is configured so that electric power supplied to the speaker 130 is limited when playback of broadcast contents which are currently played back is completed after electric power supplied to the display 120 is limited.

First, the viewer detector 151 acquires video captured by the image capturing module 150 (S401) and determines whether any viewer is present in the video or not (S402). When there is no viewer in the video (No in S402), the instruction module 152 inquires of the power controller 160 about driving power of the display 120 and determines whether electric power is supplied to the display 120 or not (S403). When electric power is supplied to the display 120 (No in S403), the instruction module 152 instructs the power controller 160 to limit electric power supplied to the display 120 (S404).

Successively, the instruction module 152 determines whether playback of currently received broadcast contents or already recorded broadcast contents by the recording/playback controller 103 is completed or not (S409). When playback of the broadcast contents is not completed (No in S409), the television apparatus 100 performs processing in S401 again.

On the other hand, when it is concluded in S402 that the presence of any viewer in the video captured by the image capturing module 150 can be confirmed (Yes in S402), the viewer detector 151 detects the line-of-sight direction, etc. of the viewer to thereby determine whether the viewer is watching the television apparatus 100 or not (S405). When the viewer is not watching the television apparatus 100 (No in S405), the instruction module 152 determines whether driving power is supplied to the display 120 or not (S406).

When electric power is not supplied to the display 120 (Yes in S406), the instruction module 152 performs processing in S409. On the other hand, when electric power is supplied to the display 120 (No in S406), the instruction module 152 instructs the display controller 121 to ratchet down luminance of the display 120 for a predetermined time and instructs the power controller 160 to limit electric power supplied to the display 120 after the predetermined time has passed (S407).

When it is concluded in S405 that the viewer is watching the television apparatus 100 (Yes in S405), the instruction module 152 instructs the power controller 160 to supply electric power to the display 120 (S408).

When the television apparatus 100 repeats processing in S401 to S409 so that playback of currently received broadcast contents or already recorded broadcast contents by the recording/playback controller 103 is completed (Yes in S409), the instruction module 152 instructs the power controller 160 to limit electric power supplied to the speaker 130 (S410).

Successively, the instruction module 152 inquires of the recording/playback controller 103 whether recording is currently performed or not, and determines whether recording is currently performed or not (S411). When recording is currently performed (Yes in S411), the television apparatus 100 performs processing in S401 again. On the other hand, when it is concluded in S411 that recording is not currently performed (No in S411), the instruction module 152 instructs the power controller 160 to limit electric power supplied to respective components of the television apparatus 100.

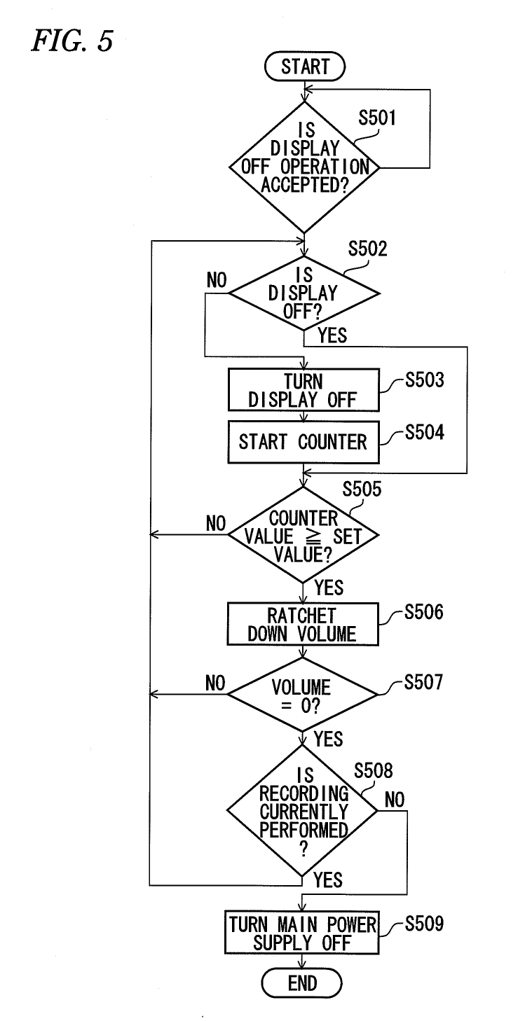

An example of processing in the television apparatus 100 according to this embodiment will be described next with reference to FIG. 5. FIG. 5 is a flow chart showing the sequence of processing performed by the television apparatus 100 when an operation input for limiting electric power supplied to the display 120 is received from the viewer.

First, when the user interface 140 receives an instruction to limit electric power supplied to the display 120 (Yes in S501), the instruction module 152 successively determines whether electric power supplied to the display 120 is performed or not (S502). When electric power supplied to the display 120 is performed (No in S502), the instruction module 152 instructs the power controller 160 to limit electric power supplied to the display 120 (S503), starts the counter (S504), and determines whether the value of the counter is a set value or more (S505). On the other hand, when it is concluded in S502 that electric power supplied to the display 120 is not performed (Yes in S502), the instruction module 152 performs processing in S505.

When it is concluded in S505 that the value of the counter is smaller than the set value (No in S505), the instruction module 152 performs processing in S502 again. When it is concluded in S505 that the value of the counter is not smaller than the set value (Yes in S505), the instruction module 152 instructs the speaker controller 131 to ratchet down the volume of audio outputted from the speaker 130 (S506). When the volume of audio becomes zero (Yes in S507), the instruction module 152 determines whether recording is currently performed or not (S508). When recording is currently performed, processing in S502 is performed again. When recording is not currently performed, the main power supply of the television apparatus 100 is limited (S509).

Although the processing flow shown in FIG. 5 has been described in the case where the volume of audio is controlled and electric power supplied to the speaker 130 is limited when a predetermined time has passed since electric power supplied to the display 120 is limited, the volume control and limitation of electric power supplied to the speaker 130 may be performed when playback of currently received broadcast contents or already recorded broadcast contents is completed after electric power supplied to the display 120 is limited, as described in the processing flow shown in FIG. 4.

According to this embodiment, the television apparatus 100 can limit electric power supplied to the display 120 while continuing electric power supplied to the speaker 130 when the presence of any viewer cannot be confirmed or when the viewer is not watching the television apparatus 100. The television apparatus 100 can further limit electric power supplied to the speaker 130 and the whole television apparatus 100 when a predetermined time has passed or when playback of broadcast contents is completed after electric power supplied to the display 120 is limited. Accordingly, the television apparatus 100 can limit power consumption of the television apparatus 100 and can provide a viewer's preferable viewing environment.

Moreover, because the television apparatus 100 can limit electric power supplied to the whole television apparatus 100 when a recording process is completed after electric power supplied to the display 120 and the speaker 130 is limited, the recording process can be continued while power consumption of the television apparatus 100 can be suppressed.

Moreover, because the television apparatus 100 can limit electric power supplied to the display 120 based on a viewer operation and can limit electric power supplied to the speaker 130 when a predetermined time has passed since the viewer operation or when playback of broadcast contents is completed after the viewer operation, electric power supplied to the display 120 can be limited at a viewer's desired timing.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A television apparatus comprising:
a display configured to display video;
an audio output module configured to output audio;
a user detection module configured to detect presence of a viewer; and
a power controller configured to supply an electric power to at least the display and the audio output module, wherein the power controller is configured to continue the electric power supplied to the audio output module while limiting the electric power supplied to the display at a first time point, and then is configured to limit the electric power supplied to the audio output module at a second time point after the first time point, if the user detection module does not detect the presence of the viewer before the first time point.

2. The apparatus of claim 1,
wherein the power controller is configured to start to limit the electric power supplied to the audio output module at the second time point after a given time has passed since the first time point.

3. The apparatus of claim 1, further comprising:
a reader configured to read video data and audio data of video contents,
wherein the display is configured to display video of the read video contents, and the audio output module is configured to output audio of the read video contents.

4. The apparatus of claim 3, wherein
the reader is configured to read playback duration information of the video contents, and
the power controller is configured to limit the electric power supplied to the audio output module and the reader at a playback end time point of the video contents based on the read playback duration information.

5. The apparatus of claim 1, further comprising:
a receiver configured to receive video data and audio data of broadcast contents and broadcast time information of the broadcast contents,
wherein:
the display is configured to display video of the received broadcast contents;
the audio output module is configured to output audio of the received broadcast contents; and
the power controller is configured to limit the electric power supplied to the audio output module at the second time point based on the broadcast time information, when broadcasting of the broadcast contents ends.

6. The apparatus of claim 5, further comprising:
a recorder configured to record video data of the broadcast contents, and
wherein the power controller is configured to limit an electric power supplied to the recorder when the recorder has recorded the broadcast contents.

7. The apparatus of claim 6,
wherein the recorder is configured to record the broadcast contents at a recording reservation time point, and
wherein the power controller is configured to limit the electric power supplied to the recorder based on the recording reservation time point, when the recorder has recorded the broadcast contents.

8. The apparatus of claim 1, wherein the audio output module is configured to ratchet down the volume of the audio after the first time point.

9. The apparatus of claim 1, wherein the display is configured to ratchet down the luminance of the video if the user detection module does not detect the presence of the viewer.

10. The apparatus of claim 1, wherein the user detection module is configured to detect the presence of the viewer, based on a signal from a sensor configured to detect the presence of the viewer.

11. The apparatus of claim 1, wherein the user detection module is configured to detect the presence of the viewer, based on an image from an image capturing device configured to capture an image of the viewer.

12. The apparatus of claim 11, wherein the user detection module is configured to detect whether the viewer is viewing the video, based on the image from the image capturing device, and
wherein the power controller is configured to limit the electric power supplied to the display at the first time point if the user detection module does not detect whether the viewer is viewing the video before the first time point.

13. A television apparatus comprising:
a display configured to display video;
an audio output module configured to output audio;
a user interface configured to receive a user operation; and
a power controller configured to supply an electric power to at least the display and the audio output module, wherein the power controller is configured to continue the electric power supplied to the audio output module while limiting the electric power supplied to the display, and then is configured to limit the electric power supplied to the audio output module, if the user interface receives the user operation.
